(19) United States
(12) Patent Application Publication
(10) Pub. No.: US 2013/0222549 A1
(43) Pub. Date: Aug. 29, 2013

(54) IMAGE PROCESSING METHOD AND IMAGE PROCESSING UNIT USING THE METHOD

(71) Applicant: SAMSUNG ELECTRONICS CO., LTD., (US)

(72) Inventors: Ki-Hyun YOON, Hwaseong-si (KR); Young Duk KIM, Hwaseong-si (KR)

(73) Assignee: SAMSUNG ELECTRONICS CO., LTD., Suwon-Si (KR)

(21) Appl. No.: 13/766,216

(22) Filed: Feb. 13, 2013

(30) Foreign Application Priority Data
Feb. 29, 2012 (KR) 10-2012-0020887

(51) Int. Cl. H04N 13/02

(52) U.S. Cl. CPC H04N 13/0239
USPC 348/47

(57) ABSTRACT

An image processing unit includes an image compensator that generates and sends a frame rate correction signal to a first image sensing unit or a second image sensing unit if a difference between first timing information and second timing information exceeds a threshold value. The first timing information is frame start information of the first image data corresponding to a first frame output from the first image sensing unit. The second timing information is frame start information of the second image data corresponding to the first frame output from the second image sensing unit. The image compensator corrects the frame rate of the first or second image sensing unit using timing information stored in first and second registers corresponding to the first and second image sensing units, thereby increasing the quality of a three-dimensional (3D) image.

### CROSS-REFERENCE TO RELATED APPLICATIONS

This application claims priority under 35 U.S.C. §119(a) from Korean Patent Application No. 10-2012-0020887 filed on Feb. 29, 2012, the disclosure of which is hereby incorporated by reference in its entirety.

### BACKGROUND

Example embodiments of inventive concepts relate to an image processing method, and more particularly, to an image processing method for increasing the quality of three-dimensional (3D) images using timing information and an image processing unit using the method.

With the recently increasing interest in 3D images, camera and display technology for shooting 3D images have received attention. The basic principle of 3D displays is giving stereoscopic perception to a viewer by presenting different images to the left and right eyes of the viewer. The stereoscopic perception can be given by displaying an image combining two images having 3D information, which have been shot using two cameras, respectively, on a display.

However, two images respectively shot by two cameras may have a time difference therebetween due to an environmental factor like fast movement of an object or due to an inherent factor like asynchronization between internal clock signals. The time difference between two images leads to an asynchronous 3D image. If two images having time difference are combined with each other to create a 3D image, a natural and stable 3D image cannot be manifested because of disagreement between objects seen by a viewer. Therefore, a technique for minimizing the time difference between two images is required to realize a high-quality 3D image.

### SUMMARY

According to some example embodiments of inventive concepts, there is provided an image processing unit including an image compensator configured to generate and send a frame rate correction signal to a first image sensing unit or a second image sensing unit if a difference between first timing information and second timing information exceeds a threshold value. The first timing information may be frame start information of the first image data corresponding to a first frame output from the first image sensing unit. The second timing information may be frame start information of the second image data corresponding to the first frame output from the second image sensing unit.

The image processing unit may further include a first register configured to store the first timing information and a second register configured to store the second timing information.

The image processing unit may further include a timer configured to generate a clock signal and to send a result of counting the clock signal to the first register and the second register. The frame start information of the first image data may be a result of counting a reception start point of the first image data corresponding to the first frame. The frame start information of the second image data may be a result of counting a reception start point of the second image data corresponding to the first frame.

The frame rate correction signal may be used to correct a frame rate by adjusting a period of time from completion of reception of the first image data corresponding to the first frame to start of reception of the third image data corresponding to a second frame.

According to other example embodiments of inventive concepts, there is provided an image processing method including storing first timing information corresponding to frame start information of first image data, the first image data corresponding to a first frame received from a first image sensing unit; storing second timing information corresponding to frame start information of second image data, the second image data corresponding to a first frame received from a second image sensing unit; and comparing a difference between the first timing information and the second timing information with a threshold value.

The image processing method may further include the image compensator generating and sending a frame rate correction signal to one of the first and second image sensing units if the difference between the first timing information and the second timing information exceeds the threshold value.

The image processing method may further include repeating the storing the first timing information, the storing the second timing information, the comparing and the generating and sending until the difference between the first timing information and the second timing information does not exceed the threshold value.

The image processing may further include the image compensator generating and sending a frame rate recovery signal to one of the first and second image sensing units, which has received the frame rate correction signal, if the difference between the first timing information and the second timing information does not exceed the threshold value.

The frame rate correction signal may be used to correct a frame rate by adjusting a period of time from completion of reception of the first image data corresponding to the first frame to start of reception of the first image data corresponding to a subsequent frame.

According to some example embodiments of inventive concepts, there is provided an image processor including an image signal processor configured to store first timing information indicating frame start information of first image data and second timing information indicating a frame start information of second image data, the first image data corresponding to a first frame received from a first image sensing unit and the second image data corresponding to a first frame received from a second image sensing unit, and an image compensator configured to change a frame rate of at least one of the first image sensing unit and the second image sensing unit based on a difference between the first timing information and the second timing information.

The image compensator may be configured to change the frame rate if the difference between the first timing information and the second timing information is above a threshold. The image compensator may be configured to change the frame rate by adjusting a period of time from completion of reception of the first image data corresponding to a first frame to start of reception of the third image data corresponding to a second frame.

### BRIEF DESCRIPTION OF THE DRAWINGS

The above and other features and advantages of example embodiments of inventive concepts will become more apparent by describing in detail example embodiments thereof with reference to the attached drawings in which:

FIG. 1A is a schematic block diagram of a three-dimensional (3D) image sensor according to some example embodiments of inventive concepts;

FIG. 1B is a schematic block diagram of a three-dimensional (3D) image sensor according to some example embodiments of inventive concepts;

FIG. 2A is a detailed block diagram of a first image sensing unit according to some example embodiments of inventive concepts;

FIG. 2B is a detailed block diagram of a first image sensing unit according to some example embodiments of inventive concept;

FIG. 3 is a detailed block diagram of an image processing unit according to some example embodiments of inventive concepts;

FIG. 4 is a flowchart of an image processing method according to some example embodiments of inventive concepts;

FIG. 5 is a detailed flowchart of an operation of receiving image data of a first or subsequent frame and storing timing information illustrated in FIG. 4;

FIG. 6 is a timing chart showing the image processing method illustrated in FIG. 4 according to some example embodiments of inventive concepts;

FIG. 7 is a timing chart showing the image processing method illustrated in FIG. 4 according to other example embodiments of inventive concepts; and

FIG. 8 is a block diagram of an image processing device including the 3D image sensor illustrated in FIG. 1.

### DETAILED DESCRIPTION OF EXAMPLE EMBODIMENTS

Example embodiments of inventive concepts will be described more fully hereinafter with reference to the accompanying drawings, in which some example embodiments are shown. This invention may, however, be embodied in many different forms and should not be construed as limited to the example embodiments set forth herein. Rather, these example embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “I”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular example embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

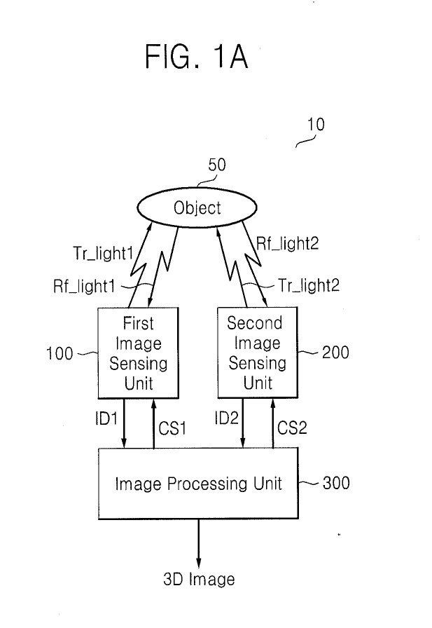

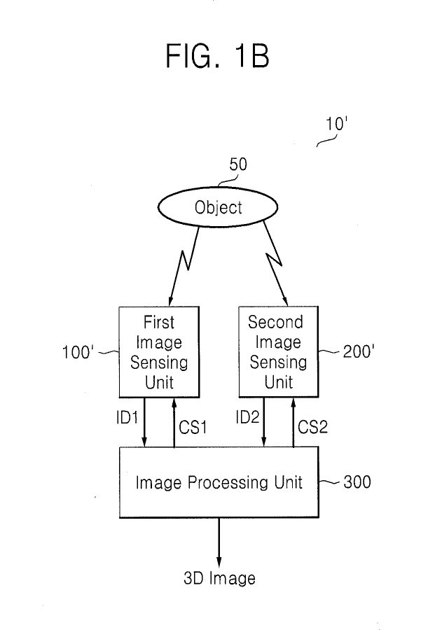

FIG. 1A is a schematic block diagram of a three-dimensional (3D) image sensor 10 according to some example embodiments of inventive concepts. The 3D image sensor 10 includes a first image sensing unit 100, a second image sensing unit 200, and an image processing unit 300.

The image processing unit 300 obtains a stereoscopic image from images of an object 50, which are respectively shot by the first and second image sensing units 100 and 200 separated from each other by a desired distance (e.g., 50 to 100 mm). For example, the 3D image sensor 10 uses a stereoscopic method. In the stereoscopic method, a 3D image is created by combining two images obtained from two respective cameras corresponding to the left and right eyes of a viewer. The average horizontal distance between the left eye and right eye of people is about 65 mm. Stereoscopic perception of an object can be obtained by utilizing the principle of binocular parallax. The 3D image sensor 10 creates a 3D image reproducing the stereoscopic perception, the depthness, and the realness of the object 50 by combining two different two-dimensional (2D) images respectively obtained from the first and second image sensing units 100 and 200 based on the principle of binocular parallax.

The first image sensing unit 100 and the second image sensing unit 200 obtain 2D image information of the object 50 using a red/green/blue (RGB) scheme and also obtain information about a distance to the object 50 using a time-of-flight (TOF) method. The TOF method is detecting a change in a phase between light Tr_light1 or Tr_light2 emitted to the object 50 with a modulated waveform and light Rf_light1 or Rf_light2 reflected from the object 50. The phase change may be calculated from the amount of charge generated in a photodiode included in a depth pixel array.

The first image sensing unit 100 and the second image sensing unit 200 respectively transmit first image data ID1 and second image data ID2, which include the 2D image information and the distance information, to the image processing unit 300. The image processing unit 300 receives the first image data ID1 and the second image data ID2 and creates a 3D image in a certain format. For example, the 3D image may be created in a format in which an image from the first image sensing unit 100 and an image from the second image sensing unit 200 are arranged side by side or a format in which vertical lines in the image from the first image sensing unit 100 and vertical lines in the image from the second image sensing unit 200 alternate with each other.

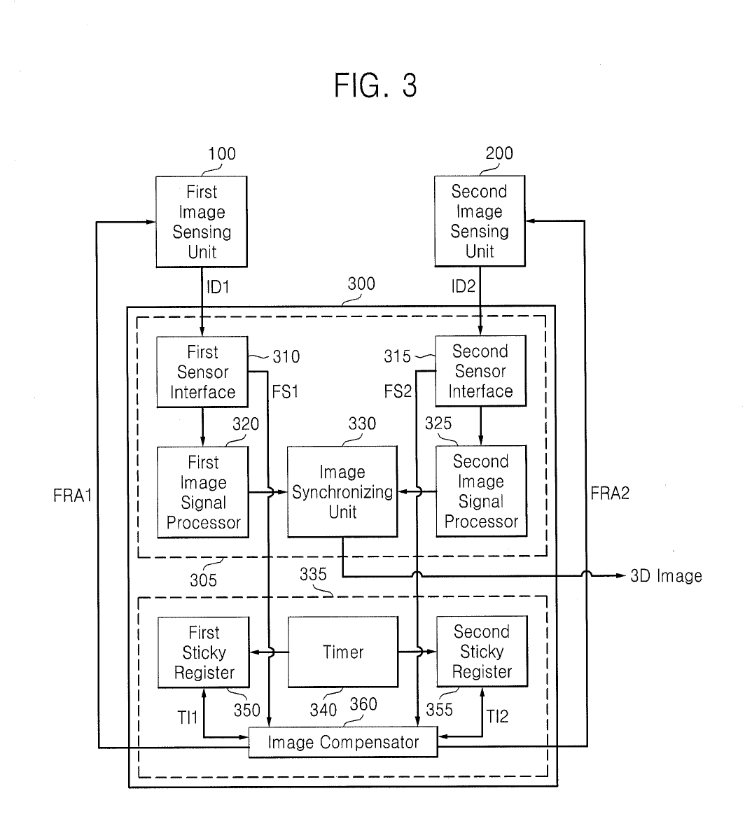

The image processing unit 300 needs to control the first and second image sensing units 100 and 200 according to the movement of the object 50, the state of illumination, and so on. The image processing unit 300 generates and transmits a first control signal CS1 and a second control signal CS2 to the first and second image sensing units 100 and 200, respectively, to control the first and second image sensing units 100 and 200. The first control signal CS1 and the second control signal CS2 include control information related with the sensitivity, exposure time and frame rate of the first and second image sensing units 100 and 200, respectively. If there is a time difference between the first image data ID1 and the second image data ID2, the quality of a 3D image degrades. To prevent this problem, the image processing unit 300 may generate control signals FRA1 and FRA2 (FIG. 3) for correcting the frame rates of the respective first and second image sensing units 100 and 200. For example, the first control signal CS1 and the second control signal CS2 may include the first and second frame rate correction signals FRA1 and FRA2, respectively. This will be described in detail later.

FIG. 1B is a schematic block diagram of a three-dimensional (3D) image sensor according to some example embodiments of inventive concepts.

To avoid redundancy, the differences between the example embodiments illustrated in FIGS. 1A and 1B will be mainly described.

The 3D image sensor 10′ includes a first image sensing unit 100′, a second image sensing unit 200′, and an image processing unit 300. The first image sensing unit 100′ and the second image sensing unit 200′ obtain only 2D image information of the object 50 using a red/green/blue (RGB) scheme. Thus, the first image sensing unit 100′ and the second image sensing unit 200′ respectively transmit first image data ID1 and second image data ID2, which include the 2D image information to the image processing unit 300. The image processing unit 300 receives the first image data ID 1 and the second image data ID2 and creates a 3D image in a certain format.

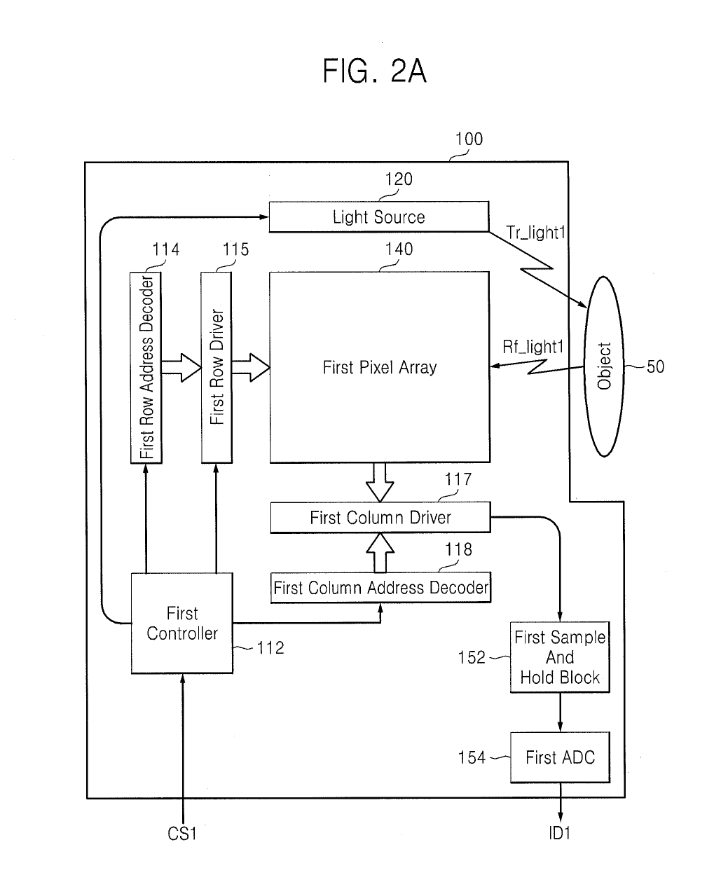

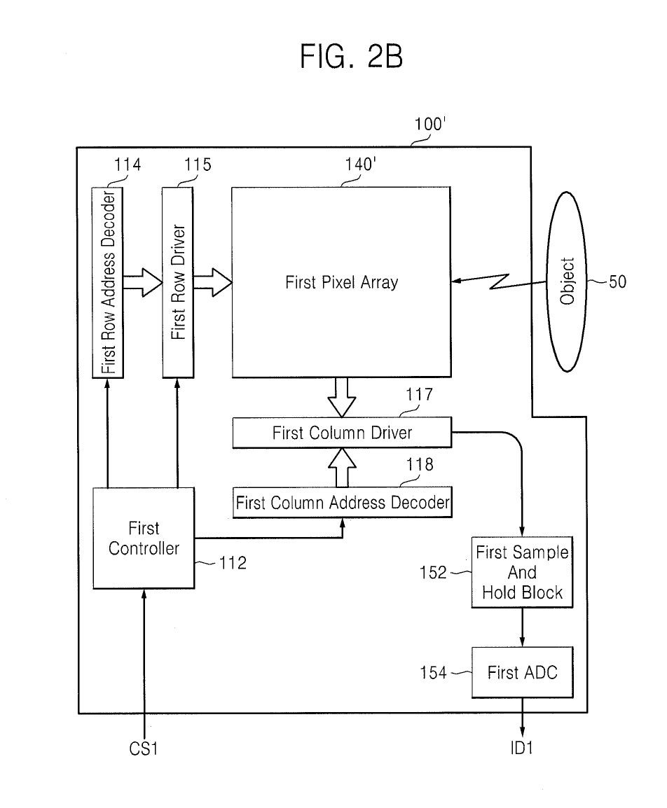

FIG. 2A is a detailed block diagram of the first image sensing unit 100 according to some example embodiments of inventive concepts. The first image sensing unit 100 illustrated in FIG. 2 is a device for obtaining a 3D image signal of the object 50. The first and second image sensing units 100 and 200 may have the same structure as each other and elements included in the first and second image sensing units 100 and 200 may have the same functions. To avoid redundancy, only the first image sensing unit 100 will be described.

The first image sensing unit 100 includes a first light source 120, a first pixel array 140, a first controller 112, a first row address decoder 114, a first row driver 115, a first column driver 117, a first column address decoder 118, a first sample and hold block 152, and a first analog-to-digital converter (ADC) 154.

The first pixel array 140 may include a plurality of unit pixel arrays. A plurality of pixels included in the first pixel array 140 may output pixel signals (including, for example, a color image signal and a depth signal) in units of columns in response to a plurality of control signals generated by the first row driver 115.

The first controller 112 outputs a plurality of control signals for controlling the operations of the first light source 120, the first pixel array 140, the first row address decoder 114, the first row driver 115, the first column driver 117, the first column address decoder 118, the first sample and hold block 152, and the first ADC 154. The first controller 112 also generates addressing signals for the outputting of signals (i.e., a color image signal and a depth signal) sensed by the first pixel array 140. For example, the first controller 112 controls the first row address decoder 114 and the first row driver 115 to select a row line connected to a certain pixel among the plurality of pixels in the first pixel array 140 so that a signal sensed by the pixel is output.

The first controller 112 may also control the first column driver 117 and the first column address decoder 118 to select a column line connected to the certain pixel.

The first controller 112 controls the first light source 120 to emit light periodically and controls the on/off timing of a photodetector that senses a distance in a pixel in the first pixel array 140.

In addition, the first controller 112 controls the timing of its control signals based on the first frame rate correction signal FRA1 (which will be described later) included in the first control signal CS1, thereby adjusting the frame rate of the first image data ID1 output from the first image sensing unit 100. Similarly, a second controller (not shown) included in the second image sensing unit 200 controls the timing of its control signals based on the second frame rate correction signal FRA2 (which will be described later) included in the second control signal CS2, thereby adjusting the frame rate of the second image data ID2 output from the second image sensing unit 200.

The first row address decoder 114 decodes a row control signal output from the first controller 112 and outputs a decoded row control signal. The first row driver 115 selectively activates a row line in the first pixel array 140 in response to the decoded row control signal output from the first row address decoder 114.

The first column address decoder 118 decodes a column control signal (e.g., an address signal) output from the first controller 112 and outputs a decoded column control signal. The first column driver 117 selectively activates a column line in the first pixel array 140 in response to the decoded column control signal output from the first column address decoder 118.

The first sample and hold block 152 samples and holds a pixel signal output from a pixel selected by the first row driver 115 and the first column driver 117. For example, the first sample and hold block 152 may sample and hold signals output from pixels selected by the first row driver 115 and the first column driver 117 from among the plurality of pixels in the first pixel array 140.

The first ADC 154 performs analog-to-digital conversion on signals output from the first sample and hold block 152 and outputs the first image data ID1 in a digital format. The first sample and hold block 152 and the first ADC 154 may be implemented together in a single chip. The first ADC 154 may include a correlated double sampling (CDS) circuit (not shown) that performs CDS on the signals output from the first sample and hold block 152. The first ADC 154 may compare a CDS signal resulting from the CDS with a ramp signal (not shown) and output a comparison result as the first image data ID 1.

Although only the first image sensing unit 100 has been described above, the second image sensing unit 200 may have the same structure as and elements performing the same functions as the first image sensing unit 100, and the second image sensing unit 200 may output the second image data ID2. In other example embodiments, the first sample and hold block 152 and the first ADC 154 may be included in a first image signal processor 320 included in the image processing unit 300, which will be described later.

FIG. 2B is a detailed block diagram of a first image sensing unit according to some example embodiments of inventive concepts.

To avoid redundancy, the differences between the example embodiments illustrated in FIGS. 2A and 2B will be mainly described.

The first pixel array 140′ may include a plurality of RGB pixel arranged in Bayer patterns. A plurality of pixels included in the first pixel array 140′ may output pixel signals (including, for example, a color image signal) in units of columns in response to a plurality of control signals generated by the first row driver 115.

The first image sensing unit 100′ may not include the first light source 120 illustrated in FIG. 2A. The first image sensing unit 100′ may output the first image data ID1, which includes only 2D image information.

FIG. 3 is a detailed block diagram of the image processing unit 300 according to some example embodiments of inventive concepts. Referring to FIGS. 1 through 3, the image processing unit 300 includes an image signal processing block 305 and an image compensation block 335.

The image signal processing block 305 includes a first sensor interface 310, a second sensor interface 315, the first image signal processor 320, a second image signal processor 325, and an image synchronizing unit 330. The first sensor interface 310 converts the first image data ID1 output from the first image sensing unit 100 into a form that can be processed by the image signal processing block 305. Similarly, the second sensor interface 315 converts the second image data ID2 output from the second image sensing unit 200 into the form that can be processed by the image signal processing block 305.

The first sensor interface 310 and the second sensor interface 315 also transmit frame start signals FS1 and FS2, respectively, to an image compensator 360 when they start to receive the first image data ID1 of a frame and the second image data ID2 of the frame, respectively. For example, the first image data ID1 and the second image data ID2 may include the frame start data FSD1 and FSD2 (not shown), respectively. The first sensor interface 310 and the second sensor interface 315 may respectively transmit the frame start signals FS1 and FS2 to the image compensator 360 as soon as they receive the frame start data FSD1 and FSD2 (not shown).

The first image signal processor 320 and the second image signal processor 325 perform digital image processing based on the first image data ID1 and the second image data ID2, respectively. The first image signal processor 320 also senses TOF based on the first image data ID1 and calculates a distance to the object 50. The first image signal processor 320 and the second image signal processor 325 also interpolate an RGBZ (where Z is depth)-formatted Bayer signals (or RGB-formatted Bayer signals) and generate a 3D (2D) image signal using an interpolated signal. The first image signal processor 320 and the second image signal processor 325 may also have functions of enhancing an edge, suppressing pseudo-color components, and so on. Example embodiments of inventive concepts are not restricted to the current example embodiments. The first image signal processor 320 and the second image signal processor 325 may be integrated into a single element to perform digital image processing.

The image synchronizing unit 330 combines a 3D (or 2D) image signal generated by the first image signal processor 320 with a 3D (or 2D) image signal generated by the second image signal processor 325, thereby generating a 3D image. For example, the 3D image may have a format in which the 3D image signals from the respective first and second image signal processors 320 and 325 are arranged side by side or a format in which vertical lines in an image corresponding to the 3D (or 2D) image signal from the first image signal processor 320 and vertical lines in an image corresponding to the 3D (or 2D) image signal from the second image signal processor 325 alternate with each other. Example embodiments of inventive concepts are not restricted to the current example embodiments. The image synchronizing unit 330 may use other schemes or algorithms to generate the 3D image.

The image compensation block 335 includes a timer 340, a first sticky register 350, a second sticky register 355, and the image compensator 360.

The timer 340 generates a clock signal and transmits a result of counting the clock signal to the first sticky register 350 and the second sticky register 355. The timer 340 may generate a clock signal with a desired frequency in a digital format, count the clock signal using a counter (not shown) included therein, and output a count result. The timer 340 may also include a reset circuit (not shown) resetting the counter when counting up to a desired number is completed.

The first sticky register 350 stores first timing information TI1 and the second sticky register 355 stores second timing information TI2. A sticky register is a register that is not initialized or modified unless the reset circuit resets the sticky register. The first timing information TI1 is frame start information of the first image data ID1 that corresponds to a first frame and is output from the first image sensing unit 100. The frame start information of the first image data ID1 is a result of counting a reception start point of the first image data ID1 corresponding to the first frame. The second timing information TI2 is frame start information of the second image data ID2 that corresponds to the first frame and is output from the second image sensing unit 200. The frame start information of the second image data ID2 is a result of counting a reception start point of the second image data ID2 corresponding to the first frame.

The first image data ID1 and the second image data ID2 include the frame start data FSD1 and FSD2 (not shown), respectively, indicating the start of a frame. For example, if the first sensor interface 310 of the image processing unit 300 senses the frame start data FSD1 (not shown) of the first frame of the first image data ID1 generated from the first image sensing unit 100, the first sensor interface 310 transmits the frame start signal FS1 of the first frame to the image compensator 360. Upon receiving the frame start signal FS1, the image compensator 360 controls the first sticky register 350 to store a count result output from the timer 340 at that moment. The count result stored in the first sticky register 350 may correspond to the frame start information or the first timing information TI1 of the first image data ID1.

Similarly, if the second sensor interface 315 of the image processing unit 300 senses the frame start data FSD2 (not shown) of the first frame of the second image data ID2 generated from the second image sensing unit 200, the second sensor interface 315 transmits the frame start signal FS2 of the first frame to the image compensator 360. Upon receiving the frame start signal FS2, the image compensator 360 controls the second sticky register 355 to store a count result output from the timer 340 at that moment. The count result stored in the second sticky register 355 may correspond to the frame start information or the second timing information TI2 of the second image data ID2.

The first timing information TI1 may be different from the second timing information TI2, which may indicate the temporal displacement between the first image data ID1 and the second image data ID2. If the difference between the first timing information TI1 and the second timing information TI2 is greater than a desired level, the quality of a 3D image synthesized by the image synchronizing unit 330 is degraded. As described above, the image compensator 360 controls the first sticky register 350 to store first timing information TI1 and the second sticky register 355 to store the second timing information TI2. The image compensator 360 reads the first timing information TI1 and the second timing information TI2, calculates the difference therebetween, and compares the calculated difference with a threshold value. If the difference between the first timing information TI1 and the second timing information TI2 does not exceed the threshold value, the image compensator 360 may generate and transmit a frame rate maintaining signal to the first image sensing unit 100 and the second image sensing unit 200. If the difference between the first timing information TI1 and the second timing information TI2 exceeds the threshold value, the image compensator 360 may generate a frame rate correction signal.

A frame rate is the number of frames of an image per unit time and usually indicates the number of frames per second, i.e., fps. The frame rate correction signal may be used to adjust the frame rate of the first image data ID1 output from the first image sensing unit 100 and the frame rate of the second image data ID2 output from the second image sensing unit 200. For example, a value obtained by dividing 1 by a period of time from the moment when the image processing unit 300 starts to receive a current frame of the first image data ID1 to the moment when the image processing unit 300 starts to receive a subsequent frame of the first image data ID1 after completing the reception of the current frame may be the frame rate of the first image sensing unit 100. Similarly, a value obtained by dividing 1 by a period of time from the moment when the image processing unit 300 starts to receive a current frame of the second image data ID2 to the moment when the image processing unit 300 starts to receive a subsequent frame of the second image data ID2 after completing the reception of the current frame may be the frame rate of the second image sensing unit 200.

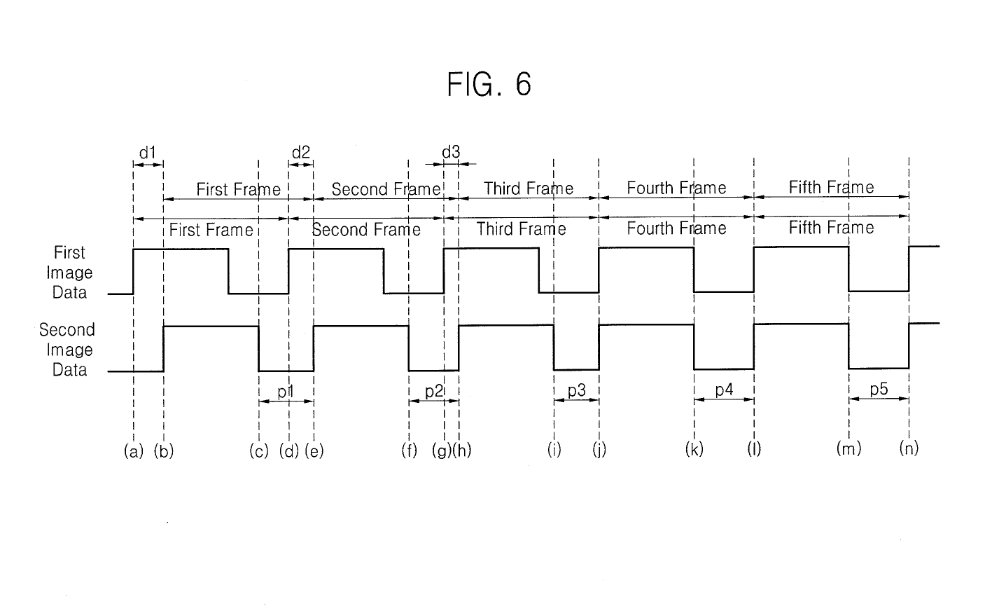

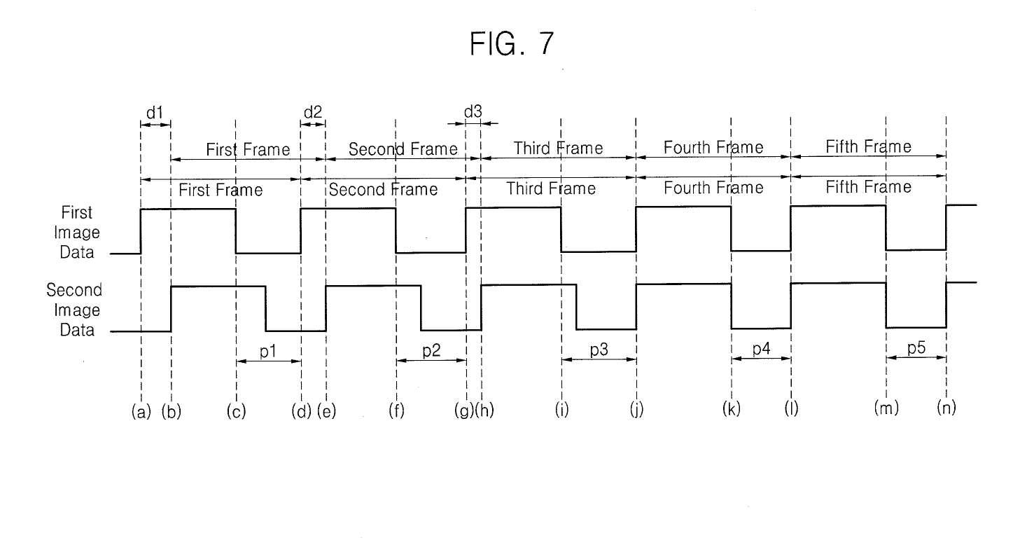

The first controller 112 and the second controller respectively included in the first image sensing unit 100 and the second image sensing unit 200 may decide the frame rate. As will be described with reference to FIGS. 6 and 7, the frame rate may be adjusted by adjusting periods p1 through p5 other than a time during which the image processing unit 300 is receiving the first image data ID1 or the second image data ID2. For example, the frame rate may be corrected by adjusting a time from the completion of reception of a current frame of the first or second image data ID or ID2 to the start of reception of a subsequent frame of the first or second image data ID1 or ID2 based on the frame rate correction signal, but example embodiments of inventive concepts are not restricted to the current example embodiments.

The threshold value is a maximum limit of time error allowed in the first image data ID1 and the second image data ID2 in the 3D image sensor 10. The threshold value may be set arbitrarily. The lower the threshold value, the more accurately the error may be reduced. However, to reduce unnecessary correction operations, the threshold value may be appropriately adjusted. The minimum limit of the threshold value may correspond to a time when image data corresponding to a pixel or a column in a first pixel array or a second pixel array is completely received by the image processing unit 300.

If the difference between the first timing information TI1 and the second timing information TI2 exceeds the threshold value and the first timing information TI1 is greater than the second timing information TI2, for example, if a frame of the first image data ID1 reaches the image processing unit 300 later than the corresponding frame of the second image data ID2, the image compensator 360 may generate a frame rate correction signal for increasing the frame rate and send it to the first image sensing unit 100. If the first controller 112 of the first image sensing unit 100 increases the frame rate, the difference between the first timing information TI1 and the second timing information TI2 is reduced. Alternatively, the image compensator 360 may generate a frame rate correction signal for decreasing the frame rate and send it to the second image sensing unit 200. If the controller of the second image sensing unit 200 decreases the frame rate, the difference between the first timing information TI1 and the second timing information TI2 is reduced.

However, if the difference between the first timing information TI1 and the second timing information TI2 exceeds the threshold value and the first timing information TI1 is less than the second timing information TI2, for example, if a frame of the first image data ID1 reaches the image processing unit 300 earlier than the corresponding frame of the second image data ID2, the image compensator 360 may generate a frame rate correction signal for decreasing the frame rate and send it to the first image sensing unit 100. If the first controller 112 of the first image sensing unit 100 decreases the frame rate, the difference between the first timing information TI1 and the second timing information TI2 is reduced. Alternatively, the image compensator 360 may generate a frame rate correction signal for increasing the frame rate and send it to the second image sensing unit 200. If the controller of the second image sensing unit 200 increases the frame rate, the difference between the first timing information TI1 and the second timing information TI2 is reduced.

Consequently, if the difference between the first timing information TI1 and the second timing information TI2 exceeds the threshold value, the image compensator 360 generates a frame rate correction signal and sends it to either of the first and second image sensing units 100 and 200 to reduce the difference between the first timing information TI1 and the second timing information TI2.

If the difference between the first timing information TI1 and the second timing information TI2 for a subsequent frame is decreased to or below the threshold value after the frame rate correction signal is generated by the image compensator 360, the image compensator 360 may generate a frame rate recovery signal. The frame rate recovery signal may be sent to either the first image sensing unit 100 or the second image sensing unit 200, which has received the frame rate correction signal. In response to the frame rate recovery signal, the first or second image sensing unit 100 or 200 may recover a frame rate used before the frame rate correction signal is received. The recovered frame rate may be a desired frame rate or may be determined by a frame rate of the first or second image sensing unit 100 or 200 that has not received the frame rate correction signal.

Although the image compensator 360 may be implemented in separate hardware, it may be implemented only in software. Accordingly, the image compensator 360 may adjust the frame rate of the first and second image sensing units 100 and 200 using the difference between the first timing information TI1 and the second timing information TI2 without separate hardware. Accordingly, the difference between the first timing information TI1 and the second timing information TI2 is reduced. As a result, the quality of a 3D image generated by the image synchronizing unit 330 is increased.

As described above, according to some example embodiments of inventive concepts, the image processing unit 300 corrects the frame rate of one of the image sensing units 100 and 200 using the timing information of the first image sensing unit 100 stored in the first sticky register 350 and the timing information of the second image sensing unit 200 stored in the second sticky register 355, thereby increasing the quality of a 3D image.

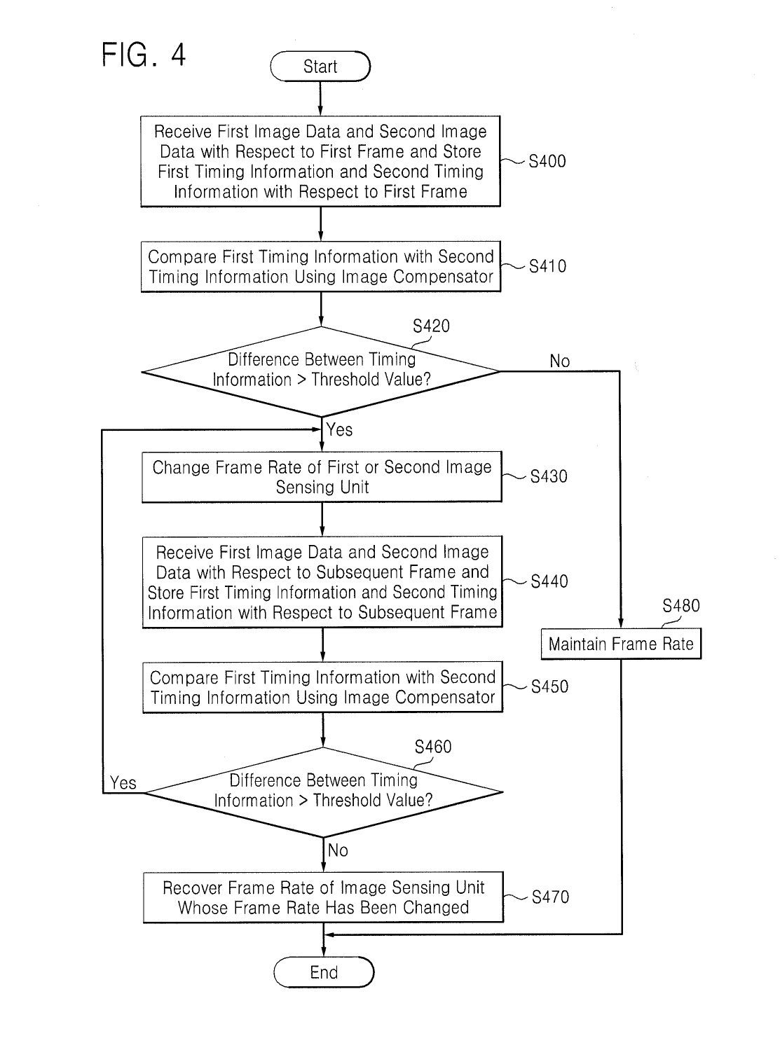

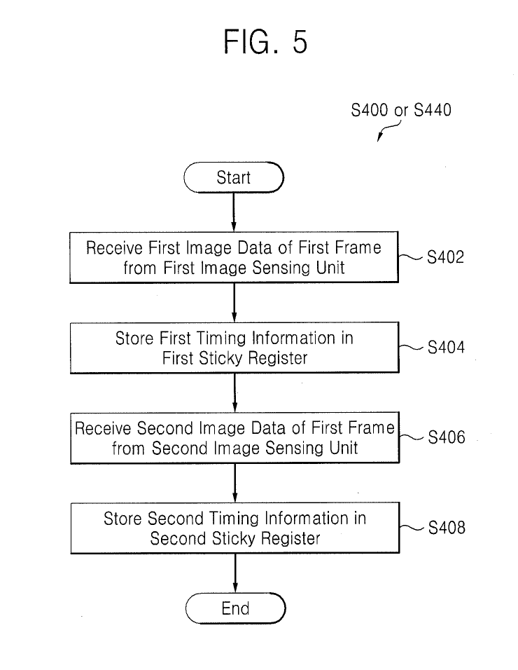

FIG. 4 is a flowchart of an image processing method according to some example embodiments of inventive concepts. FIG. 5 is a detailed flowchart of an operation of receiving image data of a first or subsequent frame and storing timing information illustrated in FIG. 4.

Referring to FIGS. 1 through 5, the first and second image sensing units 100 and 200 respectively generate the first image data ID1 and the second image data ID2 with respect to the object 50. The image processing unit 300 receives the first image data ID1 and the second image data ID2 with respect to a first frame and stores the first timing information TI1 and the second timing information TI2 in operation S400.

For example, the first sensor interface 310 receives the first image data ID1 corresponding to the first frame from the first image sensing unit 100 in operation S402. The first sensor interface 310 transmits a first frame start signal with respect to the first image data ID1 as soon as receiving the first image data ID1 corresponding to the first frame. If the image compensator 360 receives the first frame start signal with respect to the first image data ID1, the first sticky register 350 is controlled by the image compensator 360 to store a count result output from the timer 340 at that moment as the first timing information TI1 in operation S404.

The second sensor interface 315 receives the second image data ID2 corresponding to the first frame from the second image sensing unit 200 in operation S406. The second sensor interface 315 transmits a first frame start signal with respect to the second image data ID2 as soon as receiving the second image data ID2 corresponding to the first frame. If the image compensator 360 receives the first frame start signal with respect to the second image data ID2, the second sticky register 355 is controlled by the image compensator 360 to store a count result output from the timer 340 at that moment as the second timing information TI2 in operation S408. The image compensator 360 reads the first timing information TI1 and the second timing information TI2 with respect to the first frame, calculates a difference between the first timing information TI1 and the second timing information TI2, and compares the difference with a threshold value in operation S410.

If the difference between the first timing information TI1 and the second timing information TI2 does not exceed the threshold value in operation S420, the image compensator 360 may generate and send a frame rate maintaining signal to the first image sensing unit 100 and the second image sensing unit 200 in operation S480. If the difference between the first timing information TI1 and the second timing information TI2 exceeds the threshold value in operation S420, the image compensator 360 may generate the first frame rate correction signal FRA1. The first frame rate correction signal FRA1 may be sent to the first image sensing unit 100 or the second image sensing unit 200. The first or second image sensing unit 100 or 200 receiving the first frame rate correction signal FRA1 changes the frame rate according to the first frame rate correction signal FRA1 in operation S430.

The image processing unit 300 receives the first image data ID1 and the second image data ID2 with respect to the second frame and stores the first timing information TI1 and the second timing information TI2 with respect to the second frame in operation S440.

For example, the first sensor interface 310 receives the first image data ID1 corresponding to the second frame from the first image sensing unit 100 in operation S402. The first sensor interface 310 transmits a second frame start signal with respect to the first image data ID1 as soon as receiving the first image data ID1 corresponding to the second frame. If the image compensator 360 receives the second frame start signal with respect to the first image data ID1, the first sticky register 350 is controlled by the image compensator 360 to store a count result output from the timer 340 at that moment as the first timing information TI1 in operation S404.

The second sensor interface 315 receives the second image data ID2 corresponding to the second frame from the second image sensing unit 200 in operation S406. The second sensor interface 315 transmits a second frame start signal with respect to the second image data ID2 as soon as receiving the second image data ID2 corresponding to the second frame. If the image compensator 360 receives the second frame start signal with respect to the second image data ID2, the second sticky register 355 is controlled by the image compensator 360 to store a count result output from the timer 340 at that moment as the second timing information TI2 in operation S408.

The image compensator 360 reads the first timing information TI1 and the second timing information TI2 with respect to the second frame, calculates a difference between the first timing information TI1 and the second timing information TI2, and compares the difference with the threshold value in operation S450.

If the difference between the first timing information TI1 and the second timing information TI2 does not exceed the threshold value in operation S460, the image compensator 360 may generate and send a frame rate recovery signal to the first or second image sensing unit 100 or 200, which has received the frame rate correction signal. The first or second image sensing unit 100 or 200 receiving the frame rate recovery signal recovers the frame rate used before receiving the first frame rate correction signal FRA1 in operation S470.

If the difference between the first timing information TI1 and the second timing information TI2 exceeds the threshold value in operation S460, the image compensator 360 may generate the second frame rate correction signal FRA2. The second frame rate correction signal FRA2 may be sent to the first image sensing unit 100 or the second image sensing unit 200. The first or second image sensing unit 100 or 200 receiving the second frame rate correction signal FRA2 changes the frame rate according to the second frame rate correction signal FRA2 in operation S430.

Operations S430 through S460 is repeated until the image compensator 360 determines from the result of the comparison that the difference between the first timing information TI1 and the second timing information TI2 does not exceed the threshold value. If it is determined that the difference between the first timing information TI1 and the second timing information TI2 does not exceed the threshold value after a desired number of repetitions, the frame rate of the first or second image sensing unit 100 or 200 that has received the frame rate correction signal is recovered and the frame rate correction ends.

FIG. 6 is a timing chart showing the image processing method illustrated in FIG. 4 according to some example embodiments of inventive concepts. Referring to FIGS. 1 through 6, the image processing unit 300 starts to receive the first image data ID1 from the first image sensing unit 100 at a point (a). A time from the point (a) to a point (d) when the first image data ID1 starts to be received for the second time after the reception of the first image data ID1 is completed for the first time is defined as the first frame of the first image data ID1. In the same manner, the second through fifth frames of the first image data ID1 are defined.

Similarly, the image processing unit 300 starts to receive the second image data ID2 from the second image sensing unit 200 at a point (b). A time from the point (b) to a point (e) when the second image data ID2 starts to be received for the second time after the reception of the second image data ID2 is completed for the first time is defined as the first frame of the second image data ID2. In the same manner, the second through fifth frames of the second image data ID2 are defined. At the point (a), the first sensor interface 310 receives the first image data ID1 corresponding to the first frame and the first sticky register 350 is controlled by the image compensator 360 to store the first timing information TI1. At the point (b), the second sensor interface 315 receives the second image data ID2 corresponding to the first frame and the second sticky register 355 is controlled by the image compensator 360 to store the second timing information TI2. There is a time difference of “d1” between the first frame of the first image data ID1 and the first frame of the second image data ID2. Accordingly, the quality of a 3D image synthesized in the image synchronizing unit 330 is degraded. Therefore, the correction of the difference is required.

After the point (b), the image compensator 360 reads the first timing information TI1 and the second timing information TI2 and calculates the difference therebetween. The image compensator 360 compares the difference with the threshold value. If the image compensator 360 determines that the difference between the first timing information TI1 and the second timing information TI2 exceeds the threshold value, the image compensator 360 sends a frame rate correction signal to the first or second image sensing unit 100 or 200. In the example embodiments illustrated in FIG. 6, the image compensator 360 sends the frame rate correction signal for increasing the frame rate to the second image sensing unit 200. The second controller of the second image sensing unit 200 increases the frame rate. After the reception of the first frame of the second image data ID2 is completed at a point (c), a first period p1 is decreased with the increased frame rate of the second image sensing unit 200.

At the point (d), the first sensor interface 310 receives the first image data ID 1 corresponding to the second frame and the first sticky register 350 is controlled by the image compensator 360 to store the first timing information TI1. At the point (e), the second sensor interface 315 receives the second image data ID2 corresponding to the second frame and the second sticky register 355 is controlled by the image compensator 360 to store the second timing information TI2. There is a time difference of “d2” between the second frame of the first image data ID1 and the second frame of the second image data ID2. It can be seen that the time difference “d2” is reduced as compared to the time difference “d1”.

After the point (e), the image compensator 360 reads the first timing information TI1 and the second timing information TI2 and calculates the difference therebetween. The image compensator 360 compares the difference with the threshold value. If the image compensator 360 determines that the difference between the first timing information TI1 and the second timing information TI2 exceeds the threshold value, the image compensator 360 sends a frame rate correction signal for increasing the frame rate to the second image sensing unit 200. The second controller of the second image sensing unit 200 increases the frame rate. After the reception of the second frame of the second image data ID2 is completed at a point (f), a second period p2 is decreased with the increased frame rate of the second image sensing unit 200.

At a point (g), the first sensor interface 310 receives the first image data ID1 corresponding to the third frame and the first sticky register 350 is controlled by the image compensator 360 to store the first timing information TI1. At a point (h), the second sensor interface 315 receives the second image data ID2 corresponding to the third frame and the second sticky register 355 is controlled by the image compensator 360 to store the second timing information TI2. There is a time difference of “d3” between the third frame of the first image data ID1 and the third frame of the second image data ID2. It can be seen that the time difference “d3” is reduced as compared to the time difference “d2”.

After the point (h), the image compensator 360 reads the first timing information TI1 and the second timing information TI2 and calculates the difference therebetween. The image compensator 360 compares the difference with the threshold value. If the image compensator 360 determines that the difference between the first timing information TI1 and the second timing information TI2 exceeds the threshold value, the image compensator 360 sends a frame rate correction signal for increasing the frame rate to the second image sensing unit 200. The second controller of the second image sensing unit 200 increases the frame rate. After the reception of the third frame of the second image data ID2 is completed at a point (i), a third period p3 is decreased with the increased frame rate of the second image sensing unit 200.

At a point (j), the first sensor interface 310 receives the first image data ID1 corresponding to the fourth frame and the first sticky register 350 is controlled by the image compensator 360 to store the first timing information TI1. At a point rarely having a time difference from the point (j), the second sensor interface 315 receives the second image data ID2 corresponding to the fourth frame and the second sticky register 355 is controlled by the image compensator 360 to store the second timing information TI2. There is a very slight time difference between the fourth frame of the first image data ID1 and the fourth frame of the second image data ID2 as compared to the time difference “d3”.

After the point (i), the image compensator 360 reads the first timing information TI1 and the second timing information TI2 and calculates the difference therebetween. The image compensator 360 compares the difference with the threshold value. If the image compensator 360 determines that the difference between the first timing information TI1 and the second timing information TI2 does not exceed the threshold value, the image compensator 360 sends a frame rate recovery signal for recovering the frame rate to the second image sensing unit 200. The second controller of the second image sensing unit 200 recovers the frame rate to a value before the start of the first frame. After the reception of the fourth frame of the second image data ID2 is completed at a point (k), a fourth period p4 becomes the same as the first period p1 with the recovered frame rate of the second image sensing unit 200.

At a point (1) the image processing unit 300 receives the fifth frame of the first image data ID1 and the fifth frame of the second image data ID2 and stores the first timing information TI1 and the second timing information TI2. After the point (1), when the image compensator 360 determines that the difference between the first timing information TI1 and the second timing information TI2 does not exceed the threshold value, the image compensator 360 sends a frame rate maintaining signal to the first image sensing unit 100 and the second image sensing unit 200. Accordingly, the frame rate of the first and second image sensing units 100 and 200 is maintained and the time difference between the first image data ID1 and the second image data ID2 is kept very small. As a result, the image synchronizing unit 330 is able to synthesize a high-quality 3D image with no time difference.

In the example embodiments illustrated in FIG. 6, the frame rate of the second image sensing unit 200 only is corrected, but example embodiments of inventive concepts are not restricted to the current example embodiments. The correction of the frame rate may alternately be performed between the first image sensing unit 100 and the second image sensing unit 200 at each frame. In the example embodiments illustrated in FIG. 6, the frame rate correction signal is generated three times in total, but the number of times of generating the frame rate correction signal may be adjusted by adjusting the increment or decrement of the frame rate. Alternatively, the number of times (e.g., three times) of generating the frame rate correction signal may be modified if necessary.

FIG. 7 is a timing chart showing the image processing method illustrated in FIG. 4 according to other example embodiments of inventive concepts. Referring to FIGS. 1 through 7, the frame rate of the first image sensing unit 100 is adjusted in the image processing method according to the example embodiments illustrated in FIG. 7, unlike the example embodiments illustrated in FIG. 6. To avoid redundancy, the differences between the example embodiments illustrated in FIGS. 6 and 7 will be mainly described.

At the points (a) and (b), the image processing unit 300 receives the first frame of the first image data ID1 and the first frame of the second image data ID2, respectively, and stores the first timing information TI1 and the second timing information TI2. There is a time difference of “d1” between the first frame of the first image data ID1 and the first frame of the second image data ID2. Accordingly, the quality of a 3D image synthesized in the image synchronizing unit 330 is degraded. Therefore, the correction of the difference is required.

After the point (b), if the image compensator 360 determines that the difference between the first timing information TI1 and the second timing information TI2 exceeds the threshold value, the image compensator 360 sends the frame rate correction signal for decreasing the frame rate to the first image sensing unit 100. The first controller 112 of the first image sensing unit 100 decreases the frame rate. After the reception of the first frame of the first image data ID1 is completed at the point (c), the first period p1 is increased with the decreased frame rate of the first image sensing unit 100.

At the points (d) and (e), the image processing unit 300 receives the second frame of the first image data ID1 and the second frame of the second image data ID2, respectively, and stores the first timing information TI1 and the second timing information TI2. The time difference “d2” is reduced as compared to the time difference “d1” with the decreased frame rate of the first image sensing unit 100. Decreasing the frame rate of the first image sensing unit 100, receiving the first image data ID1 and the second image data ID2, and storing the first timing information TI1 and the second timing information TI2 are repeated with respect to the second and third frames from the point (e) to the point (j) according to the control of the image compensator 360.

At the point (j) and a point rarely having a time difference from the point (j), the image processing unit 300 receives the fourth frame of the first image data ID1 and the fourth frame of the second image data ID2, respectively, and stores the first timing information TI1 and the second timing information TI2. There is a very slight time difference between the fourth frame of the first image data ID1 and the fourth frame of the second image data ID2 as compared to the time difference “d3”.

After the point (j), if the image compensator 360 determines that the difference between the first timing information TI1 and the second timing information TI2 does not exceed the threshold value, the image compensator 360 sends a frame rate recovery signal for recovering the frame rate to the first image sensing unit 100. The first controller 112 of the first image sensing unit 100 recovers the frame rate to a value before the start of the first frame. After the reception of the fourth frame of the first image data ID 1 is completed at the point (k), the fourth period p4 becomes the same as the first period p1 with the recovered frame rate of the first image sensing unit 100.

At the point (1) the image processing unit 300 receives the fifth frame of the first image data ID1 and the fifth frame of the second image data ID2 and stores the first timing information TI1 and the second timing information TI2. After the point (l), if the image compensator 360 determines that the difference between the first timing information TI1 and the second timing information TI2 does not exceed the threshold value, the image compensator 360 sends a frame rate maintaining signal to the first image sensing unit 100 and the second image sensing unit 200. Accordingly, the frame rate of the first and second image sensing units 100 and 200 is maintained and the time difference between the first image data ID1 and the second image data 1D2 is kept very small. As a result, the image synchronizing unit 330 is able to synthesize a high-quality 3D image with no time difference.

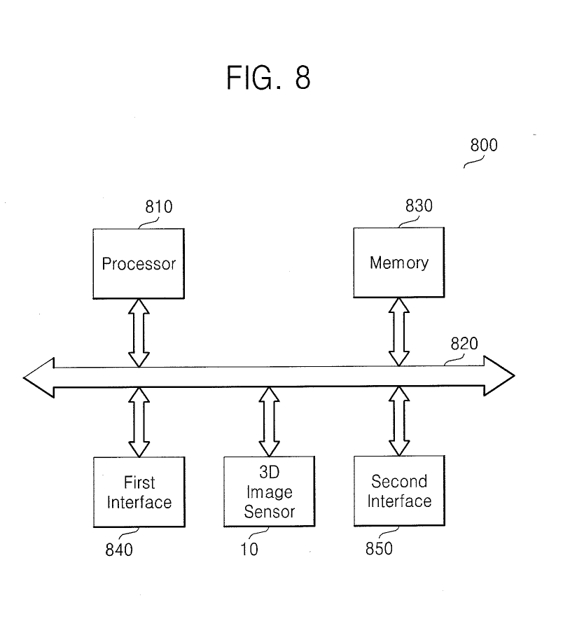

FIG. 8 is a block diagram of an image processing device 800 including the 3D image sensor 10 illustrated in FIG. 1. The image processing device 800, which is referred to as an image pick-up device, includes a processor 810, a memory 830, a first interface 840, a second interface 850, and the 3D image sensor 10, which are connected to a system bus 820.

The processor 810 controls the overall operation of the image processing device 800. The processor 810 communicates with the 3D image sensor 10 to control the operation of the 3D image sensor 10. The processor 810 may control the data write or read operation of the memory 830. The memory 830 may store 3D image data that has been processed by the 3D image sensor 10.

The first interface 840 may be implemented as an input/output interface. The processor 810 may control data to be read from the memory 830 and to be transmitted through the first interface 840 to an external device and may control data received through the first interface 840 from the external device to be stored in the memory 830. For example, the first interface 840 may be a display controller that controls the operation of a display. The display controller may transmit data processed by the 3D image sensor 10 to the display according to the control of the processor 810.

The second interface 850 may be implemented as a wireless interface. The processor 810 may control data to be read from the memory 830 and to be wirelessly transmitted through the second interface 850 to an external device and may control data wirelessly received through the second interface 850 from the external device to be stored in the memory 830.

The image processing device 800 may be implemented as a portable application including the 3D image sensor 10. The portable application may be implemented as a portable computer, a digital camera, a portable telephone, a smart phone, or a tablet personal computer (PC).

According to some example embodiments of inventive concepts, an image compensator included in an image processing unit corrects the frame rate of at least one of first and second image sensing units using timing information stored in first and second sticky registers respectively corresponding to the first and second image sensing units, thereby increasing the quality of a 3D image.

For example, without particular hardware in the first and second image sensing units, sync control is carried out by the operation of the image compensator configured in software in the image processing unit. For example, as soon as receiving first image data and second image data from the first and second image sensing units, respectively, first and second sensor interfaces immediately inform the image compensator of the reception. The image compensator records timing information at that moment in the first and second sticky registers. The image compensator compares the difference between the timing information (i.e., the time difference between the first image data and the second image data) with a threshold value and adjusts the frame rate of at least one of the first and second image sensing units, thereby performing the sync control.

While example embodiments of inventive concepts have been particularly shown and described with reference to example embodiments thereof, it will be understood by those of ordinary skill in the art that various changes in forms and details may be made therein without departing from the spirit and scope of example embodiments of inventive concepts as defined by the following claims.

What is claimed is:

1. An image processing unit, including a processor, the image processing unit comprising:
an image signal processing block configured to receive first image data from a first image sensing unit and second image data from a second image sensing unit and configured to generate a three-dimensional (3D) image; and
an image compensator configured to generate and send a frame rate correction signal to one of the first and second image sensing units if a difference between first timing information and second timing information exceeds a threshold value,
wherein the first timing information is frame start information of the first image data corresponding to a first frame output from the first image sensing unit, and
the second timing information is frame start information of the second image data corresponding to the first frame output from the second image sensing unit.

2. The image processing unit of claim 1, further comprising:
a first register configured to store the first timing information; and
a second register configured to store the second timing information.

3. The image processing unit of claim 2, further comprising:
a timer configured to generate a clock signal and configured to send a result of counting the clock signal to the first sticky register and the second sticky register, wherein the frame start information of the first image data is a result of counting a reception start point of the first image data corresponding to the first frame and wherein the frame start information of the second image data is a result of counting a reception start point of the second image data corresponding to the first frame.

4. The image processing unit of claim 1, wherein the frame rate correction signal is used to correct a frame rate by adjusting a period of time from completion of reception of the first image data corresponding to the first frame to start of reception of the first image data corresponding to a subsequent frame.

5. The image processing unit of claim 1, wherein the frame rate correction signal is used to correct a frame rate by adjusting a period of time from completion of reception of the second image data corresponding to the first frame to start of reception of the second image data corresponding to a subsequent frame.

6. The image processing unit of claim 1, wherein the threshold value is a time taken for image data corresponding to a column in one of a first pixel array and a second pixel array to be received by the image processing unit.

7. The image processing unit of claim 1, wherein the image compensator is configured to generate and send a frame rate recovery signal to one of the first and second image sensing units, which has received the frame rate correction signal, if a difference between third timing information and fourth timing information with respect to a subsequent frame does not exceed the threshold value after the image compensator generates the frame rate correction signal.

8. The image processing unit of claim 1, wherein the image compensator sends the frame rate correction signal to the first image sensing unit if the difference between the first timing information and the second timing information exceeds the threshold value and the first timing information is greater than the second timing information.

9. The image processing unit of claim 1, wherein the image compensator sends the frame rate correction signal to the second image sensing unit if the difference between the first timing information and the second timing information exceeds the threshold value and the first timing information is greater than the second timing information.

10. A three-dimensional (3D) image sensor comprising:
the image processing unit of claim 1;
the first image sensing unit; and
the second image sensing unit.

11. An image processing method comprising:
storing first timing information corresponding to frame start information of first image data, the first image data corresponding to a first frame received from a first image sensing unit;
storing second timing information corresponding to frame start information of second image data, the second image data corresponding to a first frame received from a second image sensing unit;
comparing a difference between the first timing information and the second timing information with a threshold value; and
generating and sending a frame rate correction signal to one of the first and second image sensing units if the difference between the first timing information and the second timing information exceeds the threshold value.

12. The image processing method of claim 11, wherein
the storing first timing information includes storing a result of counting a reception start point of the first image data in a first register as the first timing information and
the storing second timing information includes storing a result of counting a reception start point of the second image data in a second register as the second timing information.

13. The image processing method of claim 11, further comprising:
repeating the storing first timing information, the storing second timing information, the comparing and the generating and sending until the difference between the first timing information and the second timing information does not exceed the threshold value.

14. The image processing method of claim 13, wherein the generating and sending includes generating and sending a frame rate recovery signal to one of the first and second image sensing units, which has received the frame rate correction signal, if the difference between the first timing information and the second timing information does not exceed the threshold value.

15. The image processing method of claim 11, wherein the frame rate correction signal is used to correct a frame rate by adjusting a period of time from completion of reception of the first image data corresponding to the first frame to start of reception of the first image data corresponding to a subsequent frame.

16. An image processor, comprising:
an image signal processor configured to store first timing information indicating frame start information of first image data and second timing information indicating frame start information of second image data, the first image data corresponding to a first frame received from a first image sensing unit and the second image data corresponding to a first frame received from a second image sensing unit; and
an image compensator configured to change a frame rate of at least one of the first image sensing unit and the second image sensing unit based on a difference between the first timing information and the second timing information.

17. The image processor of claim 16, wherein the image compensator is configured to change the frame rate if the difference between the first timing information and the second timing information is above a threshold.

18. The image processor of claim 16, wherein the image compensator is configured to change the frame rate by adjusting a period of time from completion of reception of the first image data corresponding to the first frame to start of reception of third image data corresponding to a second frame.

19. The image processor of claim 16, wherein the image compensator is configured to change the frame rate of the first image sensing unit if the difference between the first timing information and the second timing information exceeds the threshold value and the first timing information is greater than the second timing information.
